(19) United States
(12) Patent Application Publication
(10) Pub. No.: US 2008/0116179 A1
(43) Pub. Date: May 22, 2008

(54) METHOD AND APPARATUS FOR ALIGNMENT OF COMPONENTS OF A PLASMA ARC TORCH

(75) Inventors: David J. Cook, Bradford, VT (US); Richard W. Couch, Hanover, NH (US); Aaron D. Brandt, Grantham, NH (US); Richard R. Anderson, Grantham, NH (US); Brian J. Currier, Newport, NH (US); Jon W. Lindsay, Hanover, NH (US); Zheng Duan, Hanover, NH (US); Casey Jones, Enfield, NH (US); Edward M. Shipulski, Etna, NH (US)

Correspondence Address: PROSKAUER ROSE LLP, ONE INTERNATIONAL PLACE, BOSTON, MA, 02110, US

(73) Assignee: Hypertherm, Inc., Hanover, NH (US)

(21) Appl. No.: 11/945,481

(22) Filed: Nov. 27, 2007

Related U.S. Application Data
(63) Continuation-in-part of application No. 11/589,448, filed on Oct. 30, 2006.
Application No. 11/589,448 is a continuation of application No. 11/347,960, filed on Feb. 6, 2006, now Pat. No. 7,193,174.
Application No. 11/347,960 is a continuation of application No. 10/999,548, filed on Nov. 30, 2004, now Pat. No. 7,019,255.
Application No. 10/999,548 is a continuation of application No. 10/411,801, filed on Apr. 11, 2003, now Pat. No. 6,946,617.

(51) Int. Cl. H05H 1/34; B23K 10/00; H05H 1/26

(52) U.S. Cl. 219/121.48; 219/121.49; 219/121.52

(57) ABSTRACT

A coolant tube and electrode are adapted to mate with each other to align the tube relative to the electrode during operation of the torch. Improved alignment ensures an adequate flow of coolant along an interior surface of the electrode. In one aspect, an elongated body of the coolant tube has a surface adapted to mate with the electrode. In another aspect, an elongated body of the electrode has a surface adapted to mate with the coolant tube. The surfaces of the tube and electrode may, for example, be flanges, tapered surfaces, contours, or steps.

### RELATED APPLICATIONS

The present application is a continuation-in-part of U.S. Ser. No. 11/589,448, filed Oct. 30, 2006, which is continuation of U.S. Ser. No. 11/347,960, filed on Feb. 6, 2006, now U.S. Pat. No. 7,193,174, which is a continuation of U.S. Ser. No. 10/999,548, filed on Nov. 30, 2004, now U.S. Pat. No. 7,019,255, which is a continuation of U.S. Ser. No. 10/411,801, filed on Apr. 11, 2003, now U.S. Pat. No. 6,946,617, the entire disclosures of which are incorporated herein by reference.

### FIELD OF THE INVENTION

The invention generally relates to the field of plasma arc torch systems and processes. In particular, the invention relates to liquid cooled electrodes and coolant tubes for use in a plasma arc torch.

### BACKGROUND OF THE INVENTION

Material processing apparatus, such as plasma arc torches and lasers are widely used in the cutting of metallic materials. A plasma arc torch generally includes a torch body, an electrode mounted within the body, a nozzle with a central exit orifice, electrical connections, passages for cooling and arc control fluids, a swirl ring to control the fluid flow patterns, and a power supply. Gases used in the torch can be non-reactive (e.g., argon or nitrogen), or reactive (e.g., oxygen or air). The torch produces a plasma arc, which is a constricted ionized jet of a plasma gas with high temperature and high momentum.

Plasma arc cutting torches produce a transferred plasma arc with a current density that is typically in the range of 20,000 to 40,000 amperes/in². High definition torches are characterized by narrower jets with higher current densities, typically about 60,000 amperes/in². High definition torches produce a narrow cut kerf and a square cut angle. Such torches have a thinner heat affected zone and are more effective in producing a dross free cut and blowing away molten metal.

Similarly, a laser-based apparatus generally includes a nozzle into which a gas stream and laser beam are introduced. A lens focuses the laser beam which then heats the workpiece. Both the beam and the gas stream exit the nozzle through an orifice and impinge on a target area of the workpiece. The resulting heating of the workpiece, combined with any chemical reaction between the gas and workpiece material, serves to heat, liquefy or vaporize the selected area of the workpiece, depending on the focal point and energy level of the beam. This action allows the operator to cut or otherwise modify the workpiece.

Certain components of material processing apparatus deteriorate over time from use. These “consumable” components include, in the case of a plasma arc torch, the electrode, swirl ring, nozzle, and shield. Ideally, these components are easily replaceable in the field. Nevertheless, the alignment of these components within the torch is critical to ensure reasonable consumable life, as well as accuracy and repeatability of plasma arc location, which is important in automated plasma arc cutting systems.

Some plasma arc torches include a liquid cooled electrode. One such electrode is described in U.S. Pat. No. 5,756,959, assigned to Hypertherm, Inc. The electrode has a hollow elongated body with an open end and a closed end. The electrode is formed of copper and includes a cylindrical insert of high thermionic emissivity material (e.g., hafnium or zirconium) which is press fit into a bore in the bottom end of the electrode. The exposed end face of the insert defines an emission surface. Often the emission surface is initially planar. However, the emission surface may be initially shaped to define a recess in the insert as described in U.S. Pat. No. 5,464,962, assigned to Hypertherm, Inc. In either case, the insert extends into the bore in the bottom end of the electrode to a circulating flow of cooling liquid disposed in the hollow interior of the electrode. The electrode can be “hollowmilled” in that an annular recess is formed in an interior portion of the bottom end surrounding the insert. A coolant inlet tube having a hollow, thin-walled cylindrical body defining a cylindrical passage extending through the body is positioned adjacent the hollow interior surface of the electrode body. The tube extends into the recess in a spaced relationship to provide a high flow velocity of coolant over the interior surface of the electrode.

In many plasma arc torches and under a variety of operating conditions (e.g., high amperage cutting), the tube must remove the heat from the electrode by providing sufficient cooling to obtain acceptable electrode life. It has been empirically determined that if the outlet of the coolant tube is misaligned (longitudinally and/or radially) with the interior surface of the electrode, the tube does not sufficiently cool the insert. Repeated use of a torch having a coolant tube misaligned with the electrode causes the insert material to more rapidly wear away. To achieve desirable coolant flow characteristics, the tube is typically secured in a fixed position relative to the electrode to achieve proper alignment. Electrode wear typically results in reduced quality cuts. For example, the kerf width dimension may increase or the cut angle may move out of square as electrode wear increases. This requires frequent replacement of the electrode to achieve suitable cut quality.

Tolerances associated with conventional methods of mounting the electrode and coolant tube makes it more difficult for systems employing such torches to produce highly uniform, close tolerance parts without requiring frequent replacement of the electrode due to the errors inherent in positioning the electrode relative to the coolant tube.

It is therefore a principal object of this invention to provide electrodes and coolant tubes for a liquid-cooled plasma arc torch that aid in maintaining electrode life and/or reducing electrode wear by minimizing the effects of misalignment.

### SUMMARY OF THE INVENTION

The invention, overcomes the deficiencies of the prior art by, in one aspect, providing a coolant tube for a plasma arc torch that achieves reliable and repeatable positioning of the coolant tube relative to the electrode. The invention, in another aspect, achieves reduced alignment errors in aligning respective longitudinal axes of an electrode and a coolant tube. The coolant tube has an elongated body that has a first end, a second end, and a coolant passage extending therethrough. The elongated body has a surface located on an exterior portion of the elongated body adapted to mate with an electrode.

Embodiments of this aspect of the invention can include the following features. The mating surface of the tube can include a contour, linear taper, step, or flange. The mating surface can have an enlarged diameter body integral with the elongated body. The enlarged diameter body can have a varying diameter. The mating surface of the tube can be fabricated so that the surface is adapted to align respective longitudinal axes of the elongated body and an electrode. The mating surface of the tube can be adapted for substantially concentrically, radially and/or circumferentially aligning respective longitudinal axes of the tube with an electrode. In addition or in the alternative, the mating surface can be adapted for aligning the elongated body and an electrode along the direction of a longitudinal axis of the elongated body. The mating surface of the tube can be located in an intermediate region between the first end and second end. The mating surface of the tube can be located at an end of the elongated body.

In another aspect, the invention includes an electrode for a plasma arc torch. The electrode includes a hollow elongated body having an open end and a closed end, and a surface located on an interior portion of the elongated body adapted to mate with a coolant tube.

Embodiments of this aspect of the invention can include the following features. The mating surface of the electrode can include a contour, linear taper, step, or flange. The mating surface can have a reduced diameter body integral with the elongated body. The reduced diameter body can have a varying diameter. The mating surface of the electrode can be adapted for substantially concentrically, radially and/or circumferentially aligning respective longitudinal axes of the electrode with a tube. In addition or in the alternative, the mating surface can be adapted for aligning the elongated body of the electrode with a tube along the direction of a longitudinal axis of the electrode.

In general, in another aspect, the invention involves a plasma arc torch that has a torch body. The plasma torch also has a coolant tube that has an elongated body. The elongated body of the tube has a first end, a second end, and a coolant passage extending therethrough, and a surface located on an exterior portion of the elongated body. The torch also has an electrode that is supported by the torch body. The electrode has a hollow elongated body that has an open end and a closed end, and a surface located on an interior portion of the elongated electrode body adapted to mate with the tube.

In this aspect of the invention, at least one of the surfaces can have a contour, linear taper, step or flange. The surface of the tube can have an enlarged diameter body integral with the elongated body of the tube, and the surface of the electrode can have a reduced diameter body integral with the elongated body of the electrode. At least one of the integral bodies can have a varying diameter. The mating surfaces can be adapted for substantially concentrically, radially and/or circumferentially aligning respective longitudinal axes of the tube and the electrode. In addition or in the alternative, the mating surfaces can be adapted for aligning the tube and an electrode along the direction of the respective longitudinal axes.

In general, in yet another aspect the invention relates to a method of locating a coolant tube relative to an electrode in a plasma arc torch. This method involves providing mating contact surfaces on the electrode and the coolant tube and biasing the electrode and the coolant tube into contact.

The method of locating the coolant tube relative to the electrode can involve biasing the tube and electrode into contact by the hydrostatic pressure of the coolant. The tube and electrode can be biased by, alternatively, a spring element.

In general, in another aspect, the invention involves a plasma arc torch that has a torch body. The torch also has a coolant tube that has an elongated body which has a first end, a second end, and a coolant passage extending therethrough. The torch also includes an electrode that is supported by the torch body. The electrode has a hollow elongated body that has an open end and a closed end. The torch also includes a means for mating surfaces of the coolant tube and the electrode.

The invention, in another aspect, achieves reduced alignment errors in aligning respective longitudinal axes of an electrode and a coolant tube. The coolant tube has an elongated body that has a first end, a second end, and a coolant passage extending therethrough. The elongated body has a surface located on an interior portion of the elongated body adapted to mate with an electrode.

The invention, in another aspect, achieves reduced alignment errors in aligning respective longitudinal axes of an electrode and a coolant tube. The coolant tube has an elongated body that has a first end, a second end, and a coolant passage extending therethrough. The elongated body has a surface located on an exterior portion of the elongated body adapted to mate with an electrode and align respective longitudinal axes of the electrode and coolant tube.

In another aspect, the invention includes an electrode for a plasma arc torch. The electrode includes a hollow elongated body having an open end and a closed end, and a surface located on an interior portion of the elongated body adapted to mate with a coolant tube and align respective longitudinal axes of the electrode and coolant tube.

In another embodiment, the invention offers an advantage over the prior art torch consumables (e.g., coolant tube and electrode) in which a mating surface is the primary measure to ensure proper alignment of the consumables.

In another embodiment, one aspect of the mating surface acts as a spacer to augment the ability to align, for example, a coolant tube and electrode when fixedly securing the coolant tube and/or electrode to a torch body.

The invention, in another aspect, features a spacer for a plasma arc torch. The spacer includes a member having an opening therethrough. The spacer also includes one or more flanges projected toward a center of the member from an outer edge of the member, the one or more flanges configured to separate an end of a coolant tube from an inner surface of an electrode.

In one embodiment, the member is a disk and the one or more flanges project toward a center of the disk from an outer ring of the member.

The invention, in another aspect, features a spacer for a plasma arc torch. The spacer includes two bars joined at a central location configured to separate an end of a coolant tube from an inner surface of an electrode.

The invention, in another aspect, features a spacer for a plasma arc torch. The spacer includes a member having an opening therethrough. The spacer also includes one or more support regions configured to separate an end of a coolant tube from an inner surface of an electrode. The spacer also includes a protrusion disposed around an outer edge of the member configured to radially align the coolant tube relative to the electrode.

In one embodiment, the member is a disk and the protrusion is a ring disposed around a circumference of the disk.

The invention, in another aspect, features a spacer for a plasma arc torch. The spacer includes a member including a mesh material. The spacer also includes one or more support regions configured to separate an end of a coolant tube from an inner surface of an electrode. The spacer also includes a protrusion disposed around an edge of the member configured to radially align the coolant tube relative to the electrode.

In one embodiment, the member is a disk and the protrusion is a ring disposed around a circumference of the disk.

The invention, in another aspect, features a spacer for a plasma arc torch. The spacer includes two bars joined at a central location configured to separate an end of a coolant tube from an inner surface of an electrode. The spacer also includes a plurality of elements located on the bars configured to radially align the coolant tube relative to the electrode.

In one embodiment, the plurality of elements are located at opposite ends of the bars. In one embodiment, the plurality of elements are positioned towards the central location at which the two bars are joined.

The invention, in another aspect, features an electrode for a plasma arc torch. The electrode includes a hollow elongated body having an open end and a closed end. The electrode also includes one or more raised features located on an inner surface of the closed end of the body configured to separate an end of a coolant tube from the inner surface of the electrode.

The invention, in another aspect, features an electrode for a plasma arc torch. The electrode includes a hollow elongated body having an open end and a closed end. The electrode also includes a surface located at the open end of the elongated body configured to separate an end of a coolant tube from the surface.

The invention, in another aspect, features a spacer for a plasma arc torch. The spacer includes an elongated body that defines a passage therethrough and a generally tubular portion configured to be disposed within an opening in an end of a coolant tube to radially align the coolant tube relative to the electrode. The spacer also includes a surface located on an outer surface of the elongated body configured to separate an end of the coolant tube from an inner surface of the electrode.

The foregoing and other objects, aspects, features, and advantages of the invention will become more apparent from the following description and from the claims.

### BRIEF DESCRIPTION OF THE DRAWINGS

The foregoing and other objects, feature and advantages of the invention, as well as the invention itself, will be more fully understood from the following illustrative description, when read together with the accompanying drawings which are not necessarily to scale.

FIG. 1 is a cross-sectional view of a prior art coolant tube disposed in a hollowmilled electrode.

FIG. 2A is a cross-sectional view of a coolant tube, according to an illustrative embodiment of the invention.

FIG. 2B is an end-view of the coolant tube of FIG. 2A.

FIG. 3 is a cross-sectional view of an electrode, according to an illustrative embodiment of the invention.

FIG. 4A is a schematic side view of a coolant tube, according to an illustrative embodiment of the invention.

FIG. 4B is an end-view of the coolant tube of FIG. 4A.

FIG. 5A is a schematic side view of a coolant tube, according to an illustrative embodiment of the invention.

FIG. 5B is an end-view of the coolant tube of FIG. 5A.

FIG. 6A is a schematic side view of a coolant tube, according to an illustrative embodiment of the invention.

FIG. 6B is an end-view of the coolant tube of FIG. 6A.

FIG. 7A is a schematic side view of a coolant tube, according to an illustrative embodiment of the invention.

FIG. 7B is an end-view of the coolant tube of FIG. 7A.

FIG. 8A is a schematic side view of a coolant tube, according to an illustrative embodiment of the invention.

FIG. 8B is an end-view of the coolant tube of FIG. 8A.

FIG. 9A is a schematic side view of a coolant tube, according to an illustrative embodiment of the invention.

FIG. 9B is an end-view of the coolant tube of FIG. 9A.

FIG. 10 is a schematic side view of an electrode, according to an illustrative embodiment of the invention.

FIG. 11 is a partial cross-section of a plasma arc torch incorporating a coolant tube and electrode of the invention.

FIG. 12 is a cross-sectional view of an electrode, according to an illustrative embodiment of the invention.

FIG. 13A is a cross-sectional view of a coolant tube, according to an illustrative embodiment of the invention.

FIG. 13B is an end-view of the coolant tube of FIG. 13A.

FIG. 14A is a cross-sectional view of a spacer, according to an illustrative embodiment of the invention.

FIG. 14B is an end-view of the spacer of FIG. 14A.

FIG. 15 is a cross-sectional view of the coolant tube of FIGS. 13A and 13B disposed in the hollow milled electrode of FIG. 12 using the spacer of FIGS. 14A and 14B, according to an illustrative embodiment of the invention.

FIG. 16A is a cross-sectional view of a spacer, according to an illustrative embodiment of the invention.

FIG. 16B is an end-view of the spacer of FIG. 16A.

FIG. 17A is a cross-sectional view of a spacer, according to an illustrative embodiment of the invention.

FIG. 17B is an end-view of the spacer of FIG. 17A.

FIG. 18 is a cross-sectional view of a coolant tube disposed in the hollow milled electrode of FIG. 12 using the spacer of FIGS. 17A and 17B, according to an illustrative embodiment of the invention.

FIG. 19A is a cross-sectional view of a spacer, according to an illustrative embodiment of the invention.

FIG. 19B is an end-view of the spacer of FIG. 19A.

FIG. 20A is a cross-sectional view of a spacer, according to an illustrative embodiment of the invention.

FIG. 20B is an end-view of the spacer of FIG. 20A.

FIG. 21 is a cross-sectional view of a coolant tube disposed in the hollow milled electrode of FIG. 12, according to an illustrative embodiment of the invention.

FIG. 22 is a cross-sectional view of a coolant tube disposed in a hollow milled electrode, according to an illustrative embodiment of the invention.

FIG. 23A is a cross-sectional view of a spacer, according to an illustrative embodiment of the invention.

FIG. 23B is an end-view of the spacer of FIG. 23A.

FIG. 24 is a cross-sectional view of a coolant tube disposed in a hollow milled electrode using a spacer, according to an illustrative embodiment of the invention.

### DETAILED DESCRIPTION OF ILLUSTRATIVE EMBODIMENTS

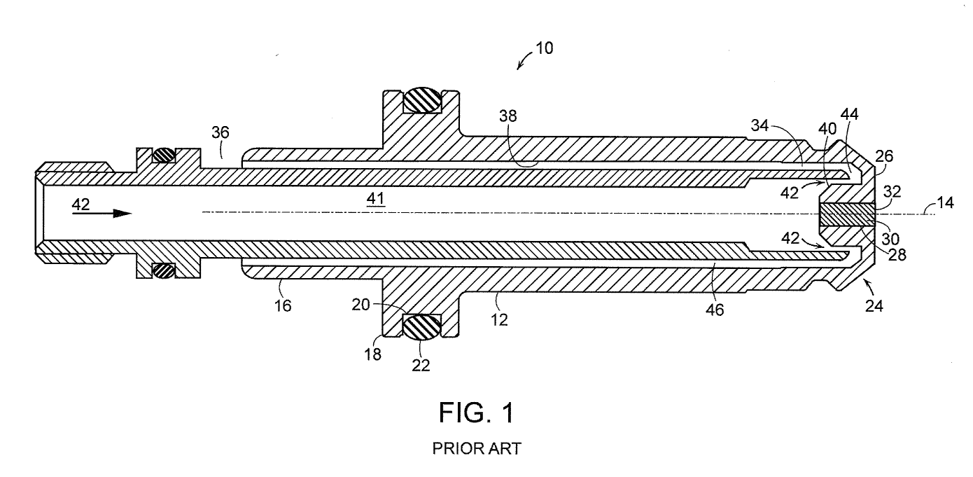

FIG. 1 illustrates a prior art coolant tube disposed in a hollowmilled electrode suitable for use in a high definition torch (e.g., the HD-3070 torch manufactured by Hypertherm, Inc.). The electrode 10 has a cylindrical copper body 12. The body 12 extends along a centerline 14 of the electrode 10, which is common to the torch when the electrode is installed therein. The electrode can be replaceably secured in a cathode block (not shown) on the torch (not shown) by an interference fit. Alternatively, threads (not shown) can be disposed along a top end 16 of the electrode 10 for replaceably securing the electrode 10 in the cathode block. A flange 18 has an outwardly facing annular recess 20 for receiving an o-ring 22 that provides a fluid seal. The bottom end 24 of the electrode tapers to a generally planar end surface 26.

A bore 28 is drilled into the bottom end 24 of the body 12 along the centerline 14. A generally cylindrical insert 30 formed of a high thermionic emissivity material (e.g., hafnium) is press fit in the bore 28. The insert 30 extends axially through the bottom end 24 to a hollow interior 34 of the electrode 10. An emission surface 32 is located along the end face of the insert 30 and exposable to plasma gas in the torch. The emission surface 32 can be initially planar or can be initially shaped to define a recess in the insert 30.

A coolant tube 36 is disposed in the hollow interior 34 adjacent the interior surface 38 of the body 12 and the interior surface 40 of the bottom end 24. The tube 36 is hollow, generally cylindrical, thin-walled and defines a large diameter coolant passage 41. The coolant tube can be replaceably secured in a torch (not shown) by threads or an interference fit. By way of example, coolant tubes sold by Hypertherm, Inc. have a coolant passage diameter of about three to about four millimeters and is positioned less than about one millimeter from the interior surface of an annular recess 44 opposite the end face 26 of the electrode to provide sufficient cooling.

The tube 36 introduces a flow 42 of coolant through the passage 41, such as water, that circulates across the interior surface 40 of the bottom end 24 and along the interior surface 38 of the body 12. The electrode is hollowmilled in that it includes the annular recess 44 formed in the interior surface 40 of the bottom end 24. The recess 44 increases the surface area of the electrode body exposed to the coolant and improves the flow velocity of the coolant across the interior surface 40 of the body 12. The electrode, alternatively, may be “endmilled” in that it does not define the annular recess 44. The flow 42 exits the electrode 10 via an annular passage 46 defined by the tube 36 and the interior surface 38 of the body 12. By way of example, when the tube 36 is used in a torch cutting at 100 amperes, the coolant flow is 1.0 gallons/minute.

During the service life of the electrode 10, the insert material wears away forming a pit of increasing depth in the bore 28. The cut quality of the torch typically degrades in conjunction with the insert wear. When the insert 30 has formed a pit of sufficient depth, a blowout condition occurs. Due to the proximity of the tube 36 to the interior surface 40 of the bottom end 24 of the electrode 10, the arc may attach to the tube during a blowout condition. The tube 36 becomes damaged by the arc and requires replacement. To prevent cut quality degradation and/or blowout, an operator typically replaces the electrode at frequent intervals. Further, manufacturers of plasma arc torch systems generally recommend replacement at certain insert wear levels to minimize the possibility of blowout.

Coolant flow 42 across the surface of the insert 30 is affected by the alignment of the coolant tube relative to the insert and, therefore, the electrode. If the outlet of the coolant tube is misaligned (e.g., longitudinally and/or radially) with respect to the interior surface 40 of the electrode 10, the coolant 42 delivered by the tube 36 does not sufficiently cool the insert 30. Repeated use of a torch having a coolant tube misaligned with respect to the electrode 10 has been empirically determined to cause the insert to more rapidly wear away.

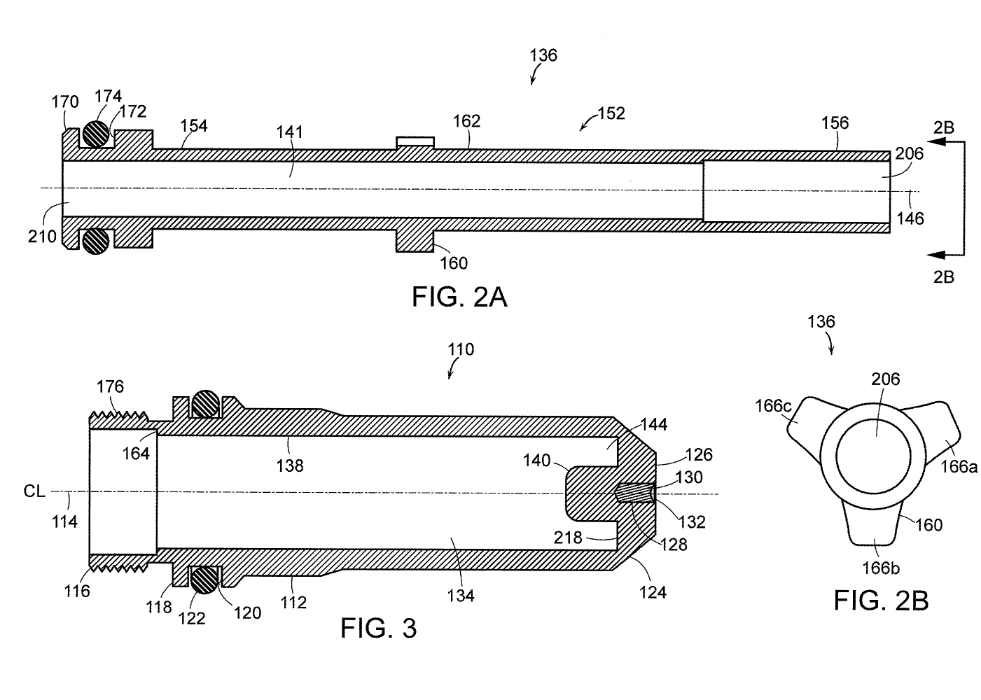

FIGS. 2A and 2B illustrate one embodiment of a coolant tube 136 incorporating the principles of the invention. The tube 136 has an elongated body 152 with a first end 154 and a second end 156 and defines a centerline or longitudinal axis 146. A coolant passage 141 extends through the elongated body 152. The first end 154 of the tube 136 has a first opening 210 in fluid communication with the passage 141. The second end 156 has a second opening 206 in fluid communication with the passage 141. According to one aspect of the invention, the tube 136 has a mating surface 160 located on an exterior surface 162 of the elongated body 152. The mating surface 160 is designed to mate with a corresponding mating surface of an electrode of a plasma torch.

The mating surface 160 is designed to permit reliable and repeatable alignment of the longitudinal axis 146 of the coolant tube 136 and a longitudinal axis, such as the longitudinal axis 114 of the electrode 110 of FIG. 3. The mating surface is capable of aligning the respective longitudinal axes of the coolant tube 136 and electrode, such that the longitudinal axes are at least substantially concentrically aligned. In addition or in the alternative, the mating surface can align the respective longitudinal axes of the coolant tube 136 and the electrode such that the coolant tube 136 and the electrode are at least substantially circumferentially aligned, thereby contemplating preferential alignment of the coolant tube 136 relative to the electrode.

It is not required that the coolant tube be rigidly attached to the torch body or the electrode. Some minimal, acceptable misalignment can, therefore, occur between the respective longitudinal axes of the coolant tube 136 and the electrode in embodiments of the invention in which the coolant tube 136 is not rigidly attached to the torch body or electrode.

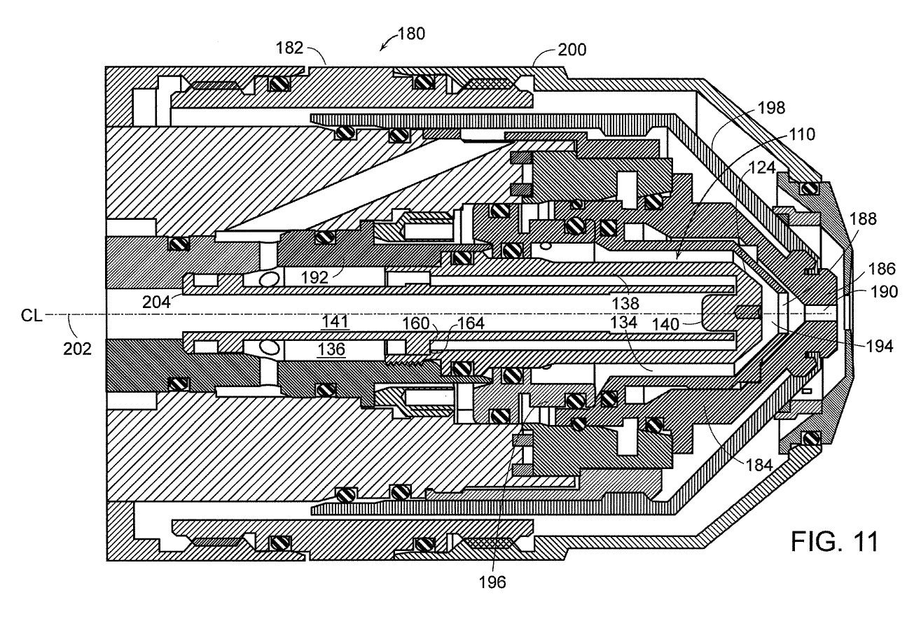

The tube 136 can be replaceably located within a torch body (see FIG. 11). The body 152 of the tube 136 has a flange 170 that has an outwardly facing annular recess 172 for receiving an o-ring 174. The o-ring 174 provides a fluid seal with the torch body (see FIG. 11) while generally allowing movement of the tube 136 along the lengthwise dimension of the body 152 of the tube 136.

The mating surface 160 of the tube 136, in this aspect of the invention, has three flanges 166a, 166b and 166c (generally 166) distributed around the exterior surface 162 of the elongated body 152 of the tube 136. The flanges 166 are generally equally spaced around the exterior surface 162. The flanges 166, in other embodiments, could be of any number, shape, or otherwise spaced around the exterior as may still permit the surface 160 to mate with a mating surface of an electrode. The surface 160, flanges 166 and/or parts thereof could be formed as an integral portion of the coolant tube 136 by, for example, machining or casting the tube 136. The surface 160, flanges 166 and/or parts thereof could, alternatively, be manufactured separately from the tube 136 and assembled or attached to the tube by, for example, a suitable adhesive or mechanical fastener.

FIG. 3 illustrates one embodiment of an electrode 110 incorporating the principles of the invention. The electrode 110 has a generally cylindrical elongated copper body 112. The body 112 generally extends along a centerline or longitudinal axis 114 of the electrode 110, which is common to the torch (not shown) when the electrode 110 is installed therein. Threads 176 disposed along a top end 116 of the electrode 110 can replaceably secure the electrode 110 in a cathode block (not shown) of the torch (not shown). A flange 118 has an outwardly facing annular recess 120 for receiving an o-ring 122 that provides a fluid seal with the torch body (not shown).

A drilled hole or bore 128 is located in a bottom end 124 of the electrode body 112 along the centerline 114. A generally cylindrical insert 130 formed of a high thermionic emission material (e.g., hafnium) is press fit into the hole 128. The insert 130 extends axially towards a hollow interior 134 of the electrode 110. An emission surface 132 is located along an end face of the insert 130 and exposable to plasma gas in the torch. The electrode is hollowmilled in that it includes an annular recess 144 formed in the interior surface 140 of the bottom end 124. The recess 144 increases the surface area of the electrode body exposed to the coolant and improves the flow velocity of the coolant across the interior surface 140 of the body 112. The electrode, alternatively, may be endmilled such that it does not define an annular recess 144.

A surface 164 is provided on an inner surface 138 of the electrode body 112 and the surface 164 is adapted for mating with a corresponding surface, such as the surface 160 of the coolant tube 136 of FIG. 2A. The surface 164 of electrode 110 may be formed on the interior surface 138 by machining or an alternative, suitable manufacturing process.

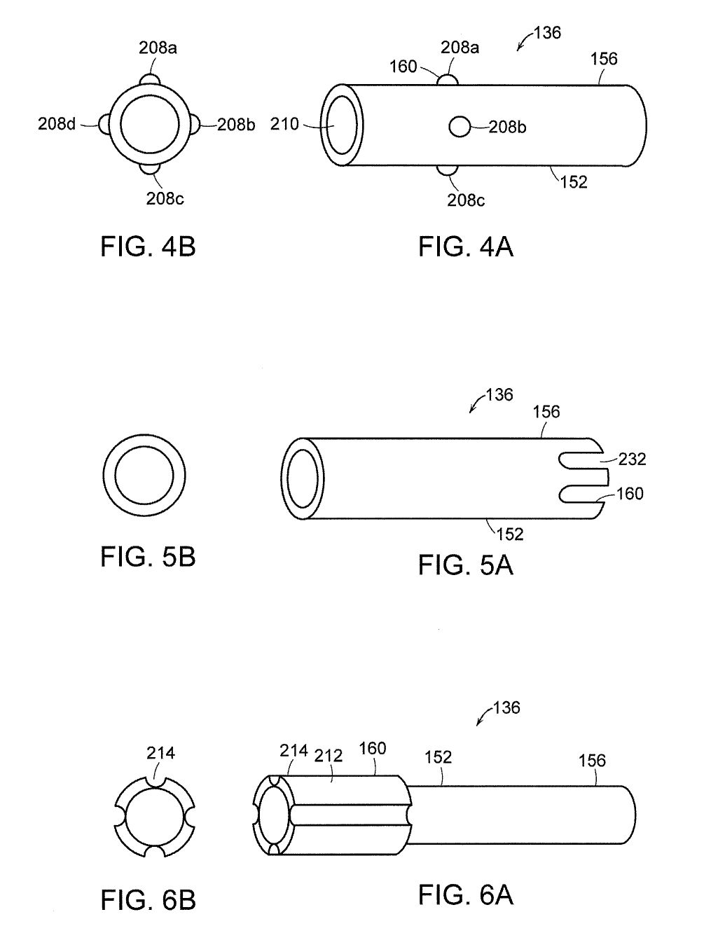

In an alternative embodiment of the invention, as illustrated in FIGS. 4A and 4B, the surface 160 of the coolant tube 136 has four spherical elements 208a, 208b, 208c, and 208d (generally 208). The four elements 208 are adapted to mate with a surface of a plasma arc torch electrode. The shape of the elements, alternatively, could be any geometric shape (e.g., ellipsoidal, diamond-shaped, or cylindrical) that is compatible with mating with a corresponding surface of an electrode and promoting adequate cooling of the electrode.

In an alternative embodiment of the invention, as illustrated in FIGS. 5A and 5B, the surface 160 of the coolant tube 136 has a plurality of slots 210 located at the second end 156 of tube 136. The slots 232 are adapted to permit coolant to flow out of the passage 141. In this embodiment, the second end 156 of the tube 136 contacts an inner surface of an electrode wall, such as the inner surface 218 of the electrode 110 of FIG. 3. The slots 232 permit adequate coolant flow across the interior surface 140 of the electrode 110.

In an alternative embodiment of the invention, as illustrated in FIGS. 6A and 6B, the surface 160 of the coolant tube 136 has an enlarged diameter body 212 relative to the body 152 of the tube 136. The body 212 has four grooves 214 oriented along the length of the body 152 of the tube 136. The enlarged diameter body 212 is adapted to mate with a surface of a plasma arc torch electrode.

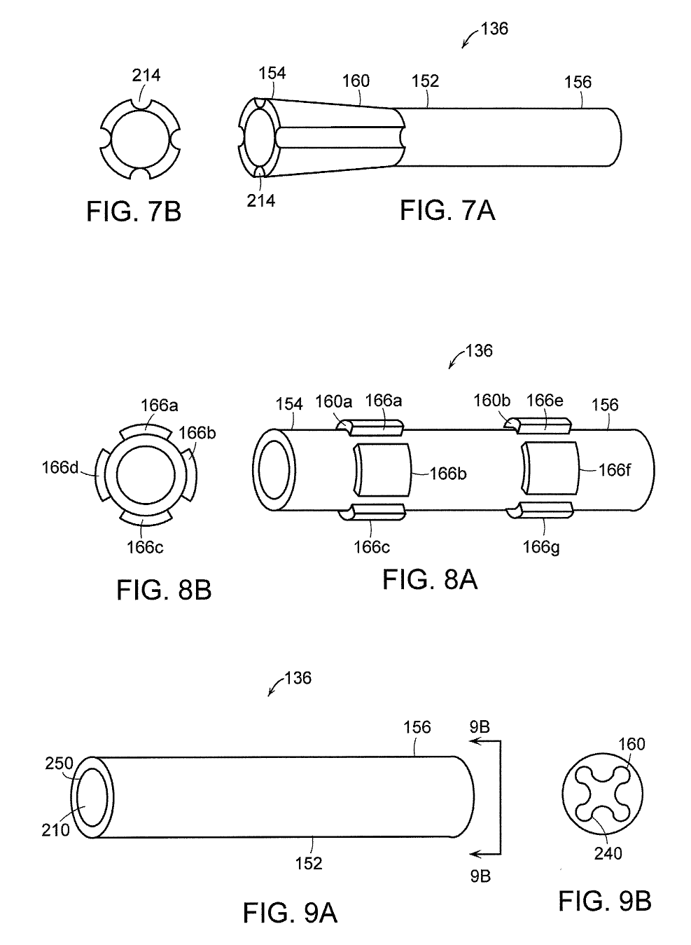

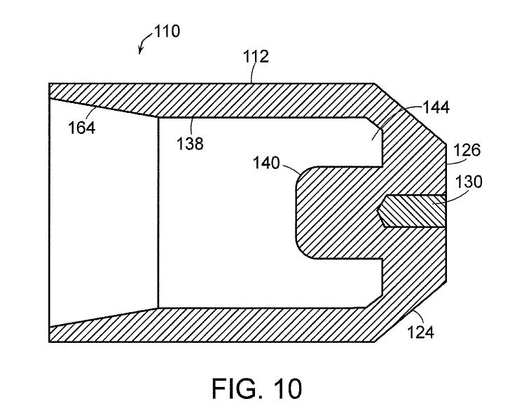

In an alternative embodiment of the invention, as illustrated in FIGS. 7A and 7B, the surface 160 of the coolant tube 136 has a contour that has a linear taper. The linear taper decreases in diameter from the first end 154 towards second end 156. The contour of the surface 160 is adapted to mate with an inside surface of an electrode, such as the surface 214 of the inside surface 138 of the electrode 110 of FIG. 10.

In an alternative embodiment of the invention, as illustrated in FIG. 10, the surface 164 of the inside surface 138 of the electrode 110 has a contour that has a linear taper that is adapted to mate with the surface 160 of a coolant tube, such as the coolant tube 136 of FIG. 7A.

In an alternative embodiment of the invention, as illustrated in FIGS. 8A and 8B, the coolant tube 136 has two surfaces 160a and 160b. The surfaces 160a and 160b are adapted to mate with corresponding surfaces of an electrode of a plasma arc torch. The surface 160a has four flanges 166a, 166b, 166c, and 166d equally spaced around the outside diameter of the body 152 of the tube 136. The surface 160b has four flanges 166e, 166f, 166g, and 166h (not shown) equally spaced around the outside diameter of the body 152 of the tube 136.

In another embodiment of the invention, as illustrated in FIGS. 9A and 9B, the coolant tube 136 has a surface 160 located on an interior surface 250 of the body 152 of the tube 136. The surface 160 is adapted to mate with an interior surface, such as the interior surface 140 of the electrode 110 of FIG. 3. The surface 160 has four flanges 240 equally spaced around the inside diameter of the body 152 of the tube 136. The flanges 240 contact the interior surface 140 of the electrode 110 when located within a plasma arc torch. By way of example, the electrode 110 can be secured in the body of a plasma arc torch such that the interior surface 140 of the electrode 110 mates with the surface 160 and flanges 240 of the tube 136, thereby aligning respective longitudinal axes of the tube 136 and electrode 136 and limiting motion of the tube 136 relative to the electrode 110.

FIG. 11 shows a portion of a high-definition plasma arc torch 180 that can be utilized to practice the invention. The torch 180 has a generally cylindrical body 182 that includes electrical connections, passages for cooling fluids and arc control fluids. An anode block 184 is secured in the body 182. A nozzle 186 is secured in the anode block 184 and has a central passage 188 and an exit passage 190 through which an arc can transfer to a workpiece (not shown). An electrode, such as the electrode 110 of FIG. 3, is secured in a cathode block 192 in a spaced relationship relative to the nozzle 186 to define a plasma chamber 194. Plasma gas fed from a swirl ring 196 is ionized in the plasma chamber 194 to form an arc. A water-cooled cap 198 is threaded onto the lower end of the anode block 184, and a secondary cap 200 is threaded onto the torch body 182. The secondary cap 200 acts as a mechanical shield against splattered metal during piercing or cutting operations.

A coolant tube, such as the coolant tube 136 of FIG. 2A is disposed in the hollow interior 134 of the electrode 110. The tube 136 extends along a centerline or longitudinal axis 202 of the electrode 110 and the torch 180 when the electrode 110 is installed in the torch 180. The tube 136 is located within the cathode block 192 so that the tube 136 is generally free to move along the direction of the longitudinal axis 202 of the torch 180. A top end 204 of the tube 136 is in fluid communication with a coolant supply (not shown). The flow of coolant travels through the passage 141 and exits an opening 206 located at a second end 156 of the tube 136. The coolant impinges upon the interior surface 140 of the bottom end 124 of the electrode 110 and circulates along the interior surface 138 of the electrode body 112. The coolant flow exits the electrode 110 via the annular passage 134 defined by the tube 136 and the interior surface 138 of the electrode.

In operation, because the coolant tube 136 is not rigidly fixed to the cathode block 180 in this embodiment of the invention, the flow or hydrostatic pressure of coolant fluid acts to bias the tube 136 towards a bottom end 124 of the electrode 110. Alternatively, a spring element (e.g., linear spring or leaf spring) may be used to bias the tube 136 towards the electrode 110. Alternatively, the electrode 110 may be threaded into the torch body until the surfaces 160 and 164 of the tube 136 and electrode 110, respectively, mate with each other, thereby biasing the surfaces 160 and 164 together. The coolant tube 136 has a surface 160 located on an exterior surface 162 of the tube body 152. The surface 160 is adapted to mate with a surface 164 located on an interior surface 138 of the electrode body 112. The surfaces 160 and 164 of the tube 136 and electrode 110, respectively, mate with each other to align the position of the tube 136 relative to the electrode 110 during operation of the torch. The tube 136 and electrode 110 are aligned longitudinally as well as radially in this aspect of the invention.

Some components of a plasma arc torch can be reused for a long period of time. However, certain plasma arc torch components deteriorate over time from use. These components are referred to as consumable components and include, in the case of a plasma arc torch, the electrode, coolant tube, spacer, swirl ring, nozzle, and shield. When these components wear out, they are replaced. Ideally, these components are easily replaceable in the field.

FIG. 12 illustrates an embodiment of an electrode 110, according to an illustrative embodiment of the invention. The electrode 110 has a generally cylindrical elongated copper body 112. The body 112 extends along a centerline or longitudinal axis 114 of the electrode 110, which is common to the torch (not shown) when the electrode 110 is installed therein. Threads 176 disposed along a top end 116 of the electrode 110 can replaceably secure the electrode 110 in a cathode block (not shown) of the torch. A flange 118 has an outwardly facing annular recess 120 for receiving an o-ring (not shown) that provides a fluid seal with the torch body (not shown).

A bore 128 (e.g., drilled, machined, or otherwise formed hole) is located in a bottom end 124 of the electrode body 112 along the centerline 114. A generally cylindrical insert 130 formed of a high thermionic emission material (e.g., hafnium) is press fit into the hole 128. The insert 130 extends axially towards a hollow interior 134 of the electrode 110. An emission surface 132 is located along an end face of the insert 130 and exposable to plasma gas in the torch.

The electrode 110 is hollowmilled in that it includes an annular recess 144 formed in the interior surface 140 of the bottom end 124 of the electrode body 112. The recess 144 includes an inner surface 218 that is oriented generally parallel with an end face 126 of the bottom end 124 of the electrode 110. The recess 144 increases the surface area of the electrode body exposed to the coolant and improves the flow velocity of the coolant across the interior surface 140 and inner surface 218 of the body 112. The electrode, alternatively, may be endmilled such that it does not define an annular recess 144.

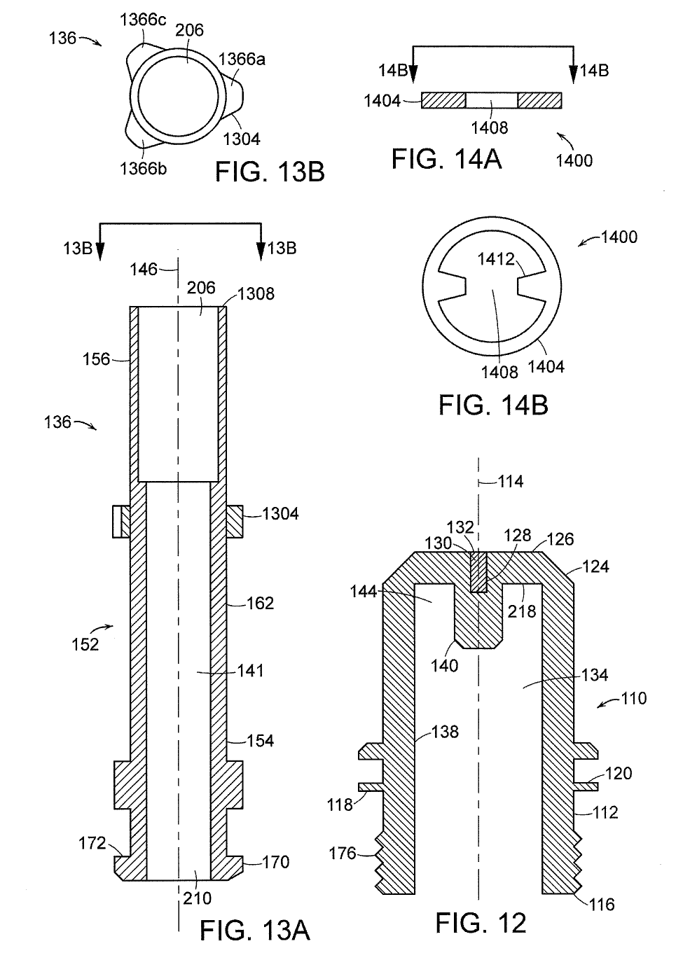

FIGS. 13A and 13B illustrate one embodiment of a coolant tube 136, according to an illustrative embodiment of the invention. The tube 136 has an elongated body 152 with a first end 154 and a second end 156 and defines a centerline or longitudinal axis 146. A coolant passage 141 extends through the elongated body 152. The first end 154 of the tube 136 has a first opening 210 in fluid communication with the passage 141. The second end 156 has a second opening 206 in fluid communication with the passage 141.

According to one aspect of the invention, the tube 136 has a surface 1304 located on an exterior surface 162 of the elongated body 152. The surface 1304 radially aligns the tube 136 relative to an interior surface 138 of the electrode 110 of FIG. 12. The surface 1304 is capable of aligning the longitudinal axis 146 of the coolant tube 136 and a longitudinal axis 114 of the electrode 110, such that the longitudinal axes are at least substantially concentrically aligned.

It is not required that the coolant tube 136 be rigidly attached to the torch body or the electrode 110. Some minimal, acceptable misalignment can, therefore, occur between the respective longitudinal axes of the coolant tube 136 and the electrode 110 in embodiments of the invention in which the coolant tube 136 is not rigidly attached to the torch body or electrode 110.

The tube 136 can be replaceably located within a torch body (similar to the tube shown in, for example, FIG. 11). The body 152 of the tube 136 has a flange 170 that has an outwardly facing annular recess 172 for receiving an o-ring (not shown). The o-ring provides a fluid seal with the torch body (see FIG. 11) while generally allowing movement of the tube 136 along the lengthwise dimension of the body 152 of the tube 136.

The surface 1304 of the tube 136, in this aspect of the invention, has three flanges 1366a, 1366b and 1366c (generally 1366) distributed around the exterior surface 162 of the elongated body 152 of the tube 136. The flanges 1366 are generally equally spaced around the exterior surface 162. The flanges 1366, in other embodiments, could be of any number, shape, or otherwise spaced around the exterior so as to permit the surface 1304 to align the tube 136 with respect to the electrode 110. The surface 1304, flanges 1366 and/or parts thereof could be formed as an integral portion of the coolant tube 136 by, for example, machining or casting the tube 136. The surface 1304, flanges 1366 and/or parts thereof could, alternatively, be manufactured separately from the tube 136 and assembled or attached to the tube 136 by, for example, a suitable adhesive, mechanical fastener, or a friction or press fit.

FIGS. 14A and 14B illustrate one embodiment of a spacer 1400, according to an illustrative embodiment of the invention. In this embodiment, the spacer 1400 is a generally circular disk 1404 that defines an opening 1408 therethrough. The disk 1404 also has two flanges 1412 projected toward the center of the disk 1404 from the outer ring of the disk 1404. The spacer 1400 is configured to be used in conjunction with the electrode 110 of FIG. 12 and the coolant tube 136 of FIGS. 13A and 13B.

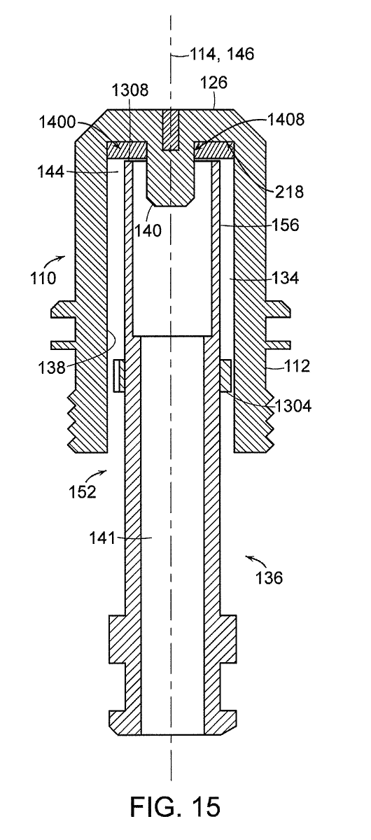

FIG. 15 is a cross-sectional view of the coolant tube 136 of FIGS. 13A and 13B disposed in the hollow milled electrode 110 of FIG. 12 using the spacer 1400 of FIGS. 14A and 14B, according to an illustrative embodiment of the invention. The spacer 1400 is located in the annular recess 144 of the electrode 110. The inner surface 140 of the electrode 110 is located in the opening 1408 of the spacer 1400. The spacer 1400 is used to separate the second end 156 of the coolant tube 136 from the inner surface 218 of the body 112 of the electrode 110. The end face 1308 of the second end 156 of the coolant tube 136 is located adjacent (or in contact with) the flanges 1412 of the spacer 1400. The flanges 1412 separate the second end 156 of the coolant tube 136 from the inner surface 218 of the body 112 of the electrode 110. In use, fluid flowing out of the second end 156 of the tube 136 flows across the interior surface 140 and inner surface 218 of the body 112 because the second end 156 of the tube 136 is separated from the inner surface 218 of the electrode 110.

In some embodiments, the spacer 1400 is press fit or friction fit in to the annular recess 144 of the electrode 110. In some embodiments, the spacer 1400 fits loosely within the annular recess 144 of the electrode 110. In some embodiments, the spacer 1400 is fixed within the annular recess of the electrode 110 with, for example, an adhesive or mechanical fastener. In some embodiments, elements of the spacer 1400 (e.g., the disk 1404 and flanges 1412) are located on the coolant tube 136 to separate the second end 156 of the coolant tube 136 from the inner surface 218 of the body 112 of the electrode 110.

In an alternative embodiment, the spacer 1400 is not disk-shaped. In this embodiment, the spacer 1400 includes a member that defines an opening therethrough, The spacer also has two flanges projected toward the center of the member from the outer edge of the member. The member can be any shape (e.g., rectangular, square, irregular) such that it can be located in the annular recess 144 of the electrode 110.

In other embodiments of the invention, the shape of the spacer 1400, disk 1404 and flanges 1412, alternatively, could be any geometric shape (e.g., rectangular, square, or irregular) that is compatible with corresponding surfaces of the electrode and coolant tube. Alternative numbers and orientations of flanges 1412 can be used in alternative embodiments of the invention.

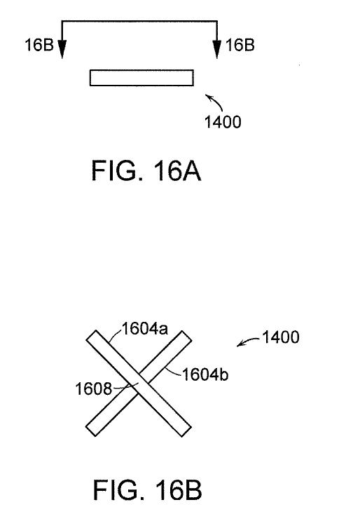

In an alternative embodiment of the invention, as illustrated in FIGS. 16A and 16B, the spacer 1400 has an X shape formed by two generally rectangular bars 1604a and 1604b that are joined at a central location 1608. The spacer 1400 of FIGS. 16A and 16B is configured such that the rectangular bars 1604a and 1604b are located adjacent to (or in contact with) the end face of an end of a coolant tube when installed in a torch. For example, the spacer 1400 of FIGS. 16A and 16B can be used in an alternative embodiment of the invention to separate the end face 1308 of the second end 156 of the coolant tube 136 of FIGS. 13A and 13B from the inner surface 218 of the body 112 of the electrode 110 of FIG. 12.

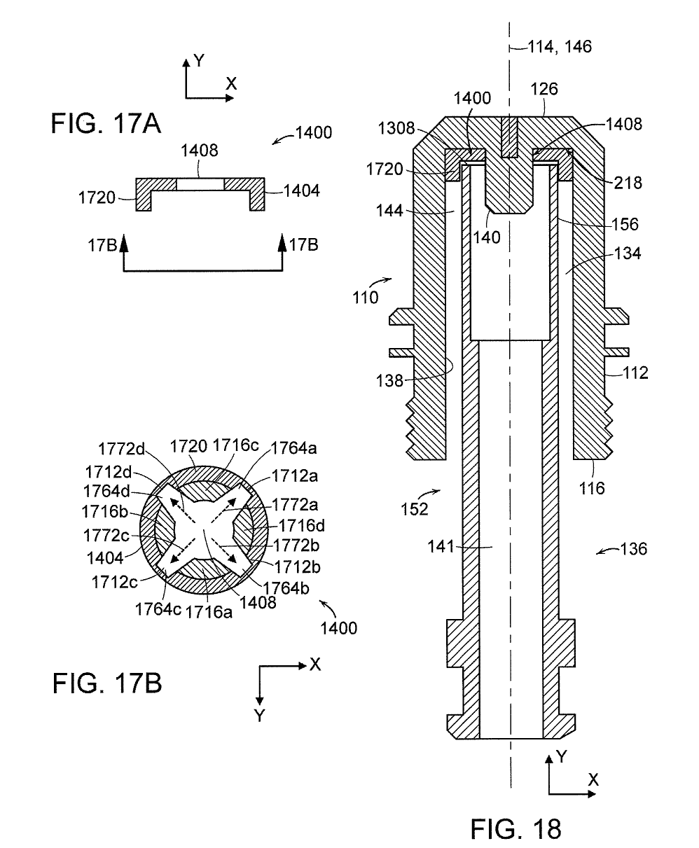

In an alternative embodiment of the invention, as illustrated in FIGS. 17A and 17B, the spacer 1400 is a generally circular disk 1404 that defines an opening 1408 through the spacer 1400. The spacer 1400 has a ring 1720 disposed around the circumference of the disk 1404. The disk 1404 also defines four channels 1712a, 1712b, 1712c and 1712d (generally 1712) through the spacer 1400 that permit fluid to flow through the channels 1712. The spacer 1400 also has four support regions 1716a, 1716b, 1716c and 1716d (generally 1716) located between the channels 1712. The spacer 1400 is configured to be used in conjunction with, for example, an electrode 110 and coolant tube 136 of FIG. 18.

In an alternative embodiment, the spacer 1400 is not disk-shaped. In this embodiment, the spacer 1400 includes a member that defines an opening therethrough, The spacer also has a protrusion (rather than a ring) disposed around an outer edge of the member configured to radially align the coolant tube relative to the electrode. The member can be any shape (e.g., rectangular, square, irregular) such that it can be located in the annular recess 144 of the electrode 110.

FIG. 18 is a cross-sectional view of a coolant tube 136 in a hollow milled electrode 110 using the spacer of FIGS. 17A and 17B, according to an illustrative embodiment of the invention. In this embodiment, the coolant tube 136 lacks the surface 1304 and flanges 1366 of the tube 136 of FIGS. 13A and 13B. The spacer 1400 is located in the annular recess 144 of the electrode 110. The inner surface 140 of the electrode 110 passes through the opening 1408 of the spacer 1400.

The spacer 1400 is used to separate the end face 1308 of the second end 156 of the coolant tube 136 from the inner surface 218 of the body 112 of the electrode 110. The end face 1308 of the second end 156 of the coolant tube 136 is located within the ring 1720 of the spacer 1400. The ring 1720 radially aligns the tube 136 relative to the interior surface 138 of the electrode 110. The ring 1720 aligns the longitudinal axis of the coolant tube 136 relative to the longitudinal axis of the electrode 110, such that the longitudinal axes are at least substantially concentrically aligned.

The end face 1308 of the second end 156 of the coolant tube 136 is also located adjacent to (or in contact with) the support regions 1716 of the spacer 1400. The support regions 1716 are separated by the channels 1712. For example, channel 1712d separates support region 1716b from support region 1716c. The regions 1716 separate the end face 1308 of the second end 156 of the coolant tube 136 from the inner surface 218 of the body 112 of the electrode 110. Fluid flows through the coolant tube 136 in the positive Y-direction of the coolant tube 136. Fluid flowing out of the second end 156 of the tube 136 flows through the channels 1712 along directions 1772a, 1772b, 1772c and 1772d (generally 1772) and across the interior surface 140 and inner surface 218 of the body 112 because the second end 206 of the tube 136 is separated from the inner surface 218 of the electrode 110. The fluid then flows through regions 1764a, 1764b, 1764c and 1764d (generally 1764) along the negative Y-direction of the coolant tube 136 in the region between the interior surface 138 of the electrode 110 and outer surface of the coolant tube 136.

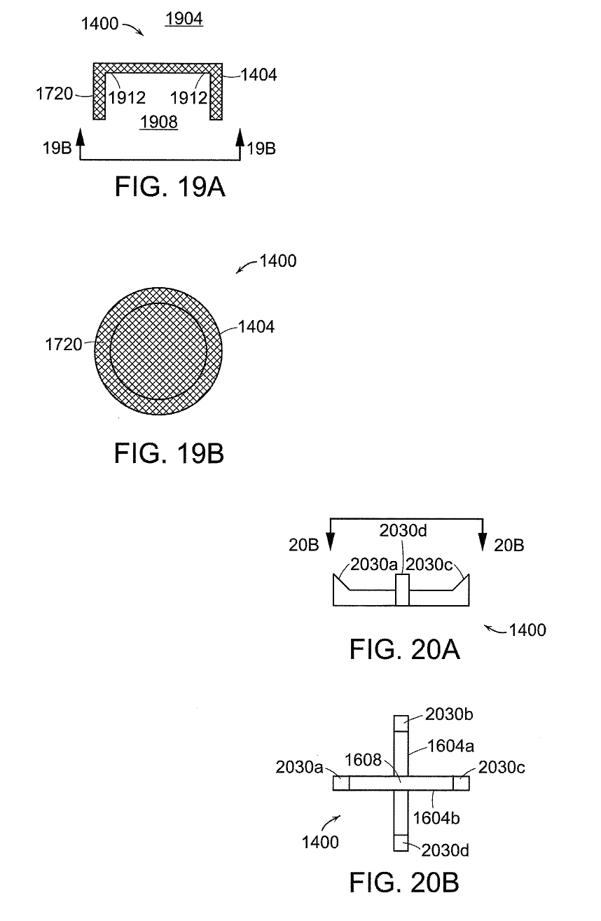

In an alternative embodiment of the invention, as illustrated in FIGS. 19A and 19B, the spacer 1400 is a generally circular disk 1404. The spacer 1400 has a ring 1720 disposed around the circumference of the disk 1404. The spacer 1400 is fabricated using a mesh material that permits fluid to flow through the spacer 1400. For example, fluid is capable of passing through the mesh material between a first side 1904 of the spacer 1400 to a second side 1908 of the spacer 1400.

The spacer 1400 is used to separate the end face 1308 of the second end 156 of the coolant tube 136 from the inner surface 218 of the body 112 of the electrode 110, similarly as described herein with respect to FIGS. 17A, 17B and 18. The end face 1308 of the second end 156 of the coolant tube 136 is located within the ring 1720 of the spacer 1400. The ring 1720 radially aligns the tube 136 relative to the interior surface 138 of the electrode 110. The ring 1720 aligns the longitudinal axis of the coolant tube 136 relative to the longitudinal axis of the electrode 110, such that the longitudinal axes are at least substantially concentrically aligned.

The end face 1308 of the second end 156 of the coolant tube 136 is also located adjacent to (or in contact with) regions 1912 of the spacer 1400. The regions 1716 separate the end face 1308 of the second end 156 of the coolant tube 136 from the inner surface 218 of the body 112 of the electrode 110. In use, fluid flowing out of the end face 1308 of the second end 156 of the tube 136 flows through the mesh material of the spacer 1400 and across the interior surface 140 and inner surface 218 of the body 112 because the second end 156 of the tube 136 is separated from the inner surface 218 of the electrode 110.

In an alternative embodiment, the spacer 1400 is not disk-shaped. In this embodiment, the spacer 1400 includes a member comprising a mesh material. The spacer also has a protrusion (rather than a ring) disposed around an outer edge of the member configured to radially align the coolant tube relative to the electrode. The member can be any shape (e.g., rectangular, square, irregular) such that it can be located in the annular recess 144 of the electrode 110.

In an alternative embodiment of the invention, as illustrated in FIGS. 20A and 20B, the spacer 1400 has two generally rectangular bars 1604a and 1604b that are joined at a central location 1608. The spacer 1400 of FIGS. 20A and 20B is configured such that the rectangular bars 1604a and 1604b are located adjacent to (or in contact with) the end face of an end of a coolant tube. For example, the spacer 1400 of FIGS. 20A and 20B can be used in an alternative embodiment of the invention to separate the end face 1308 of the second end 156 of the coolant tube 136 of FIG. 18 from the inner surface 218 of the body 112 of the electrode 110 of FIG. 18. The spacer 1400 of FIGS. 20A and 20B also has four wedge-shaped elements 2030a, 2030b, 2030c and 2030d (generally 2030). Elements 2030a and 2030c are located at opposite ends of rectangular bar 1604b. Elements 2030b and 2030d are located at opposite ends of rectangular bar 1604a.

The end face 1308 of the second end 156 of the coolant tube 136 is located within the elements 2030 of the spacer 1400. The elements 2030 radially align the tube 136 relative to the interior surface 138 of the electrode 110. The elements 2030 align the longitudinal axis of the coolant tube 136 relative to the longitudinal axis of the electrode 110, such that the longitudinal axes are at least substantially concentrically aligned.

The end face 1308 of the second end 156 of the coolant tube 136 is also located adjacent to (or in contact with) the rectangular bars 1604 of the spacer 1400. The rectangular bars 1604 separate the end face 1308 of the second end 156 of the coolant tube 136 from the inner surface 218 of the body 112 of the electrode 110.

In an alternative embodiment, the four wedge-shaped elements 2030a, 2030b, 2030c and 2030d (generally 2030) are not located at opposite ends of the rectangular bars. Rather, the wedge-shaped elements are positioned closer towards the central location 1608 of the spacer such that they fit within the second opening 206 of the tube 136 to both radially align the tube 136 relative to the interior surface 138 of the electrode 110 and align the longitudinal axis of the coolant tube 136 relative to the longitudinal axis of the electrode 110, such that the longitudinal axes are at least substantially concentrically aligned.

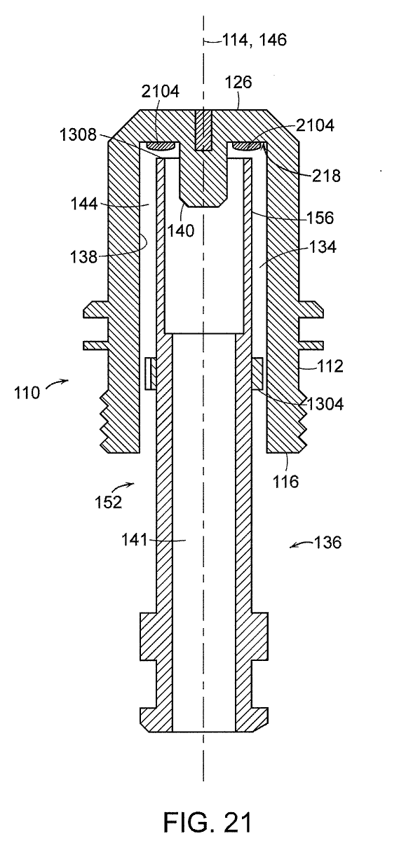

FIG. 21 is a cross-sectional view of the coolant tube 136 of FIGS. 13A and 13B disposed in the hollow milled electrode 110 of FIG. 12 using raised features 2104 to separate the end face 1308 of the second end 156 of the coolant tube 136 from the inner surface 218 of the body 112 of the electrode 110, according to an illustrative embodiment of the invention. The features 2104 are curved elements located on the inner surface 218 in the annular recess 144 of the electrode 110. The inner surface 140 of the electrode 110 passes between the features 2104. The end face 1308 of the second end 156 of the coolant tube 136 is located adjacent to (or in contact with) the features 2104. In some embodiments, the features 2104 are formed as an integral portion of the electrode 110. In some embodiments, the features 2104 are attached to the electrode, for example, by an adhesive or by welding the features 2104 to the inner surface 218 of the electrode 110.

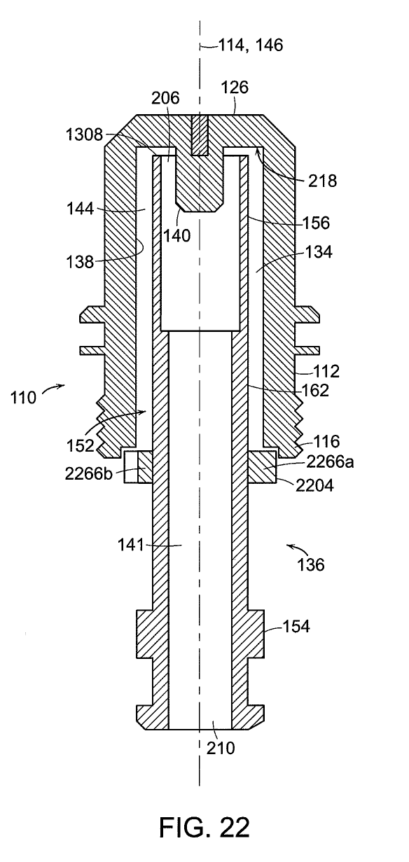

FIG. 22 is a cross-sectional view of a coolant tube 136 disposed in a hollow milled electrode 110. The coolant tube 136 has an elongated body 152 with a first end 154 and a second end 156 and defines a centerline or longitudinal axis 146. A coolant passage 141 extends through the elongated body 152. The first end 154 of the tube 136 has a first opening 210 in fluid communication with the passage 141. The second end 156 has a second opening 206 in fluid communication with the passage 141.

According to one aspect of the invention, the tube 136 has a surface 2204 located on an exterior surface 162 of the elongated body 152. The surface 2204 of the tube 136 has three flanges 2266a, 2266b and 2266c (not shown for clarity of illustration purposes) distributed around the exterior surface 162 of the elongated body 152 of the tube 136. The flanges 2266a, 2266b and 2266c (generally 2266) are equally spaced around the exterior surface 162.

The top end 116 of the electrode 110 has an annular recess 2240 adapted to mate with the surface 2204 of the elongated body 152 of the tube 136 to permit reliable and repeatable alignment of the coolant tube 136 and the electrode 110. The surface 2204 and the flanges 2266 are configured to separate the end face 1308 of the second end 156 of the coolant tube 136 from the inner surface 218 of the body 112 of the electrode 110. The combination of the annular recess 2240 of the electrode 110 and the surface 2204 and flanges 2266 of the tube 136 align the respective longitudinal axes of the coolant tube 136 and electrode 110, such that the longitudinal axes are at least substantially concentrically aligned. The combination of the annular recess 2240 of the electrode 110 and the surface 2204 and flanges 2266 of the tube 136 also radially align the tube 136 relative to the electrode 110. The annular surface of the electrode 110 may be formed by machining or an alternative, suitable manufacturing process.

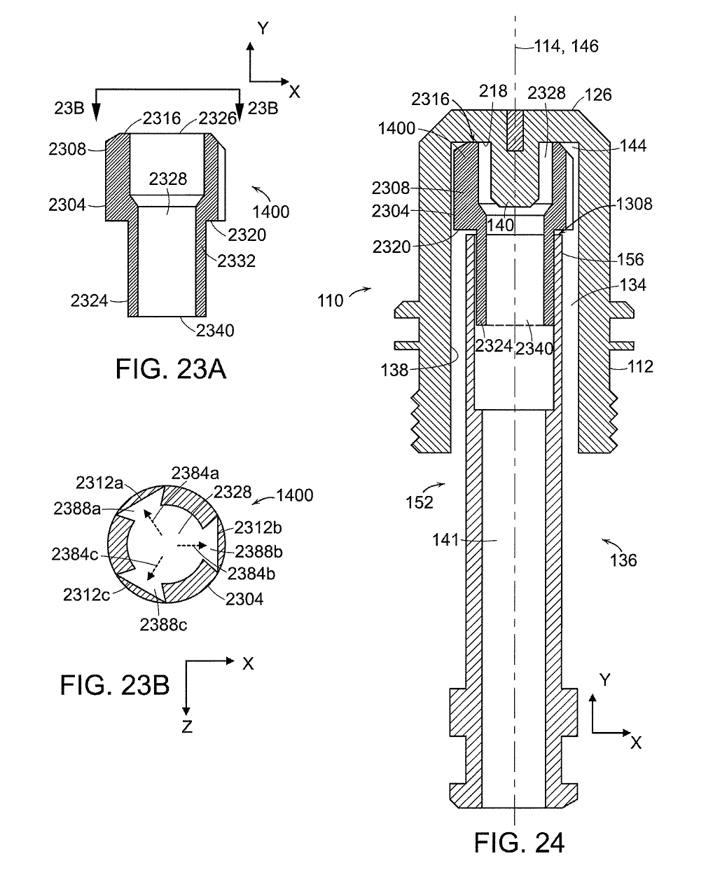

In an alternative embodiment of the invention, as illustrated in FIGS. 23A and 23B, the spacer 1400 is an elongated generally cylindrical body 2304 that defines a passage 2328 through the spacer 1400. The body 2304 of the spacer 1400 has a first end 2308 and a second end 2324. The first end 2308 of the body 2304 has an end face 2316 and defines an opening 2326 in communication with the passage 2328. The second end 2324 defines an opening 2340 in communication with the passage 2328. The body 2304 has a surface 2320 provided on an outer surface 2332 of the body 2304 of the spacer 1400. The surface 2320 is adapted for mating with a corresponding surface of a coolant tube, for example, the end face 1308 of the coolant tube 136 of FIG. 13A. The body 2304 of the spacer 1400 also defines three channels 2312a, 2312b and 2312c (generally 2312) that permit fluid to flow through the channels 2312.

FIG. 24 is a cross-sectional view of the coolant tube 136 of FIGS. 13A and 13B in the hollow milled electrode 110 of FIG. 12 using the spacer 1400 of FIGS. 23A and 23B, according to an illustrative embodiment of the invention. In this embodiment, the coolant tube 136 lacks the surface 1304 and flanges 1366 of the tube 136 of FIGS. 13A and 13B. The spacer 1400 is located in the annular recess 144 of the electrode 110. The end face 2316 of the spacer 1400 is adjacent to (or in contact with) the surface 218 of the electrode 110.

The spacer 1400 is used to separate the end face 1308 of the second end 156 of the coolant tube 136 from the inner surface 218 of the body 112 of the electrode 110. The end face 1308 of the second end 156 of the coolant tube 136 is adjacent to (or in contact with) the surface 2320 of the body 2304 of the spacer 1400. A generally cylindrical, tubular portion of the second end 2324 of the body 2304 of the spacer 1400 is disposed within the passage 141 of the coolant tube 136 and substantially concentrically aligns the longitudinal axis 146 of the coolant tube 136 with respect to the longitudinal axis 114 of the electrode 110.

In use, fluid flows through the coolant tube 136 in the positive Y-direction of the coolant tube 136. Fluid flowing out of the second end 156 of the tube 136 flows through the passage 2328 along the positive Y-direction of the spacer 1400. The fluid then flows across the inner surface 218 of the electrode 110 along directions 2384a, 2384b and 2384c (generally 2384) toward the outer edge of the body 2304 of the spacer 1400. The fluid then flows through regions 2388a, 2388b and 2388c (generally 2388) along the negative Y-direction of the coolant tube 136 in the region between the interior surface 138 of the electrode 110 and outer surface of the coolant tube 136.

Variations, modifications, and other implementations of what is described herein will occur to those of ordinary skill without departing from the spirit and the scope of the invention. Accordingly, the invention is not to be defined only by the preceding illustrative description.

What is claimed is:

1. A spacer for a plasma arc torch, the spacer comprising:
a member comprising an opening therethrough; and
one or more flanges projected toward a center of the member from an outer edge of the member, the one or more flanges configured to separate an end of a coolant tube from an inner surface of an electrode.

2. The spacer of claim 1, wherein the member is a disk and the one or more flanges project toward a center of the disk from an outer ring of the member.

3. A spacer for a plasma arc torch, the spacer comprising:
two bars joined at a central location configured to separate an end of a coolant tube from an inner surface of an electrode.

4. A spacer for a plasma arc torch, the spacer comprising:
a member comprising an opening therethrough;
one or more support regions configured to separate an end of a coolant tube from an inner surface of an electrode; and
a protrusion disposed around an outer edge of the member configured to radially align the coolant tube relative to the electrode.

5. The spacer of claim 4, wherein the member is a disk and the protrusion is a ring disposed around a circumference of the disk.

6. A spacer for a plasma arc torch, the spacer comprising:
a member comprising a mesh material;
one or more support regions configured to separate an end of a coolant tube from an inner surface of an electrode; and
a protrusion disposed around an edge of the member configured to radially align the coolant tube relative to the electrode.

7. The spacer of claim 6, wherein the member is a disk and the protrusion is a ring disposed around a circumference of the disk.

8. A spacer for a plasma arc torch, the spacer comprising:
two bars joined at a central location configured to separate an end of a coolant tube from an inner surface of an electrode; and
a plurality of elements located on the bars configured to radially align the coolant tube relative to the electrode.

9. The spacer of claim 8, wherein the plurality of elements are located are located at opposite ends of the bars.

10. The spacer of claim 8, wherein the plurality of elements are positioned towards the central location at which the two bars are joined.

11. An electrode for a plasma arc torch, the electrode comprising:
a hollow elongated body having an open end and a closed end; and
one or more raised features located on an inner surface of the closed end of the body configured to separate an end of a coolant tube from the inner surface of the electrode.

12. An electrode for a plasma arc torch, the electrode comprising:
a hollow elongated body having an open end and a closed end; and
a surface located at the open end of the elongated body configured to separate an end of a coolant tube from the surface.

13. A spacer for a plasma arc torch, the spacer comprising:
an elongated body that defines a passage therethrough and a generally tubular portion configured to be disposed within an opening in an end of a coolant tube to radially align the coolant tube relative to the electrode; and
a surface located on an outer surface of the elongated body configured to separate an end of the coolant tube from an inner surface of the electrode.
